(19) United States
(12) Patent Application Publication
(10) Pub. No.: US 2025/0373856 A1
(43) Pub. Date: Dec. 4, 2025

(54) SIGNALING OPTIMIZATION TECHNIQUES IN VIDEO BITSTREAMS

(71) Applicant: Tencent America LLC, Palo Alto, CA (US)

(72) Inventors: Shan LIU, San Jose, CA (US); Stephan WENGER, Hillsborough, CA (US)

(73) Assignee: Tencent America LLC, Palo Alto, CA (US)

(21) Appl. No.: 19/301,853

(22) Filed: Aug. 15, 2025

Related U.S. Application Data
(63) Continuation of application No. PCT/US2024/024747, filed on Apr. 16, 2024.
(60) Provisional application No. 63/460,564, filed on Apr. 19, 2023.

(51) Int. Cl. H04N 19/70

(52) U.S. Cl. CPC H04N 19/70

(57) ABSTRACT

A method includes receiving a coded video bitstream comprising coded information of one or more pictures, and determining a signaled value of a syntax element from the coded video bitstream. The syntax element is associated with a use state of an optimization technique for encoding the one or more pictures into the coded video bitstream by an encoder, the syntax element is structured to have at least three possible values corresponding to three use states of the optimization technique, a first value of the syntax element indicates an unknown state of the optimization technique for encoding the one or more pictures, a second value of the syntax element indicates a used state of the optimization technique for encoding the one or more pictures, and a third value of the syntax element indicates a no-use state of the optimization technique for encoding the one or more pictures.

### RELATED APPLICATIONS

The present application is a continuation of International Application No. PCT/US2024/024747, entitled “SIGNALING OPTIMIZATION TECHNIQUES IN VIDEO BITSTREAMS” and filed on Apr. 16, 2024, which claims the benefit of priority to U.S. Provisional Application No. 63/460,564, entitled “SIGNALING OPTIMIZATION TECHNIQUES IN VIDEO BITSTREAMS” and filed on Apr. 19, 2023. The entire disclosures of the prior applications are hereby incorporated by reference.

### TECHNICAL FIELD

The present disclosure describes embodiments generally related to video coding, including the signaling of optimizations of the video bitstream as applied by an encoder, for example in a video coding for machines scenario.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding. In some examples, an apparatus for video decoding includes processing circuitry.

Some aspects of the disclosure provide a method of processing visual media data. The method includes performing a conversion between a visual media file and a bitstream of visual media data according to a format rule. The bitstream includes a first signaled value of a first syntax element and a second signaled value of a second syntax element, the first signaled value and the second signaled value are signaled individually, the first syntax element is associated with a first use state of a foreground pre-processing technique, the second syntax element is associated with a second use state of a background pre-processing technique. The format rule specifies that the first syntax element is structured to have at least three possible values corresponding to three use states of the foreground pre-processing technique, a first value of the first syntax element indicates an unknown state of the foreground pre-processing technique, a second value of the first syntax element indicates a used state of the foreground pre-processing technique, and a third value of the first syntax element indicates a no-use state of the foreground pre-processing technique. The second syntax element is structured to have at least three possible values corresponding to three use states of the background pre-processing technique, a first value of the second syntax element indicates an unknown state of the background pre-processing technique, a second value of the second syntax element indicates a used state of the background pre-processing technique, and a third value of the second syntax element indicates a no-use state of the background pre-processing technique. In an example, the format rule specifies that the first syntax element and the second syntax element are reset to the unknown state upon an end of a persistence interval.

Some aspects of the disclosure provide a method for video decoding. The method includes receiving a coded video bitstream comprising coded information of one or more pictures, and determining a signaled value of a syntax element from the coded video bitstream. The syntax element is associated with a use state of an optimization technique for encoding the one or more pictures into the coded video bitstream by an encoder, the syntax element is structured to have at least three possible values corresponding to three use states of the optimization technique, a first value of the syntax element indicates an unknown state of the optimization technique for encoding the one or more pictures, a second value of the syntax element indicates a used state of the optimization technique for encoding the one or more pictures, and a third value of the syntax element indicates a no-use state of the optimization technique for encoding the one or more pictures. The method also includes processing the coded information of the one or more pictures according to the signaled value of the syntax element associated with the optimization technique.

In some examples, the optimization technique includes at least one of a region-of-interest (ROI) pre-processing technique, a foreground pre-processing technique, a background pre-processing technique, a temporal sub-sampling technique, a spatial sub-sampling technique, a quantization parameter adaption for ROI technique, and a quantization step changes for temporal layers technique.

In some examples, the syntax element is parsed from a supplementary enhancement information (SEI) message. In some examples, the syntax element is parsed from at least one of a sequence parameter set, a video parameter set, a picture parameter set, an adaptation parameter set, a picture header, a slice header, a group of block (GOB) header, and a group of picture (GOP) header.

In some examples, the method includes parsing the coded information to obtain a presence flag that indicates whether a group of syntax elements for a group of optimization techniques is present in the coded information. When the presence flag indicates an existence of the group of syntax elements, the method includes parsing the coded information to obtain values of the group of syntax elements.

In some examples, the method includes setting an initial state of the optimization technique to be the unknown state.

In some examples, the method includes determining a persistence interval for the optimization technique based on a persistence that is signaled in the coded information, and setting the use state of the optimization technique to be the unknown state upon an end of the persistence interval.

In some examples, the method includes determining a first signaled value of a first syntax element and a second signaled value of a second syntax element from the coded information of the one or more pictures, the first syntax element is associated with a first use state of a foreground pre-processing technique on the one or more pictures, the second syntax element is associated with a second use state of a background pre-processing technique on the one or more pictures.

In some examples, the signaled value of the syntax element indicates the unknown state, the signaled value of the syntax element is inserted by a device that is configured to switch from a first source to a second source for providing the coded video bitstream.

In some examples, the method includes parsing an update flag from the coded video bitstream, the update flag indicating whether an update to one or more optimization techniques is coded into the coded information. When the update flag indicates that the update is coded into the coded information, the method includes determining a specific optimization technique based on an identification of the specific optimization technique in the coded video bitstream, and determining one or more attributes of the specific optimization technique from the coded video bitstream.

Some aspects of the disclosure provide another method for video decoding. The method includes receiving a coded video bitstream comprising coded information of one or more pictures, and determining a first signaled value of a first syntax element and a second signaled value of a second syntax element from the coded video bitstream. The first signaled value and the second signaled value are signaled individually, the first syntax element is associated with a first use state of a foreground pre-processing technique by an encoder that encodes the one or more pictures into the coded video bitstream, the second syntax element is associated with a second use state of a background pre-processing technique by the encoder. The method further includes processing the coded information of the one or more pictures according to the first signaled value of the first syntax element and the second signaled value of the second syntax element.

In some examples, the first syntax element is structured to have at least two possible values corresponding to two use states of the foreground pre-processing technique, a first value of the first syntax element indicates a used state of the foreground pre-processing technique for encoding the one or more pictures, and a second value of the first syntax element indicating a no-use state of the foreground pre-processing technique for encoding the one or more pictures.

In some examples, the second syntax element is structured to have at least two possible values corresponding to two use states of the background pre-processing technique, a first value of the second syntax element indicates a used state of the background pre-processing technique for encoding the one or more pictures, and a second value of the second syntax element indicating a no-use state of the background pre-processing technique for encoding the one or more pictures.

In some examples, the first syntax element is structured to have at least three possible values corresponding to three use states of the foreground pre-processing technique, a first value of the first syntax element indicates an unknown state of the foreground pre-processing technique for encoding the one or more pictures, a second value of the first syntax element indicates a used state of the foreground pre-processing technique for encoding the one or more pictures, and a third value of the first syntax element indicates a no-use state of the foreground pre-processing technique for encoding the one or more pictures.

In some examples, the second syntax element is structured to have at least three possible values corresponding to three use states of the background pre-processing technique, a first value of the second syntax element indicates an unknown state of the background pre-processing technique for encoding the one or more pictures, a second value of the second syntax element indicates a used state of the background pre-processing technique for encoding the one or more pictures, and a third value of the second syntax element indicates a no-use state of the background pre-processing technique for encoding the one or more pictures.

In some examples, the first syntax element and the second syntax element are parsed from a supplementary enhancement information (SEI) message.

In some examples, the first syntax element and the second syntax element are parsed from at least one of a sequence parameter set, a video parameter set, a picture parameter set, an adaptation parameter set, a picture header, a slice header, a group of block (GOB) header, and a group of picture (GOP) header.

In some examples, the method includes parsing the coded information to obtain a presence flag that indicates whether a group of at least the first syntax element and the second syntax element is present in the coded information, and when the presence flag indicates an existence of the group of at least the first syntax element and the second syntax element, the method includes parse the coded information to obtain the first signaled value of the first syntax element and the second signaled value of the second syntax element.

According to another aspect of the disclosure, an apparatus is provided. The apparatus includes processing circuitry. The processing circuitry can be configured to perform any of the described methods for video decoding/encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a video processing system (100).

FIG. 2 is a schematic illustration of an exemplary block diagram of a decoder.

FIG. 3 is a schematic illustration of an exemplary block diagram of an encoder.

FIG. 4 shows a block diagram of a video processing system in a machine scenario in some examples.

FIG. 5 shows a table of syntaxes and semantics that can be a part of an SEI message in some examples.

FIG. 6 shows another table of syntaxes and semantics that can be a part of an SEI message in some examples.

FIG. 7 shows a flow chart outlining a decoding process according to some embodiments of the disclosure.

FIG. 8 shows a flow chart outlining another decoding process according to some embodiments of the disclosure.

FIG. 9 is a schematic illustration of a computer system in accordance with an embodiment.

### DETAILED DESCRIPTION OF EMBODIMENTS

Some aspects of the disclosure provide techniques of video coding for machines. In some examples, video encoders that conform to video coding standards, such as ITU-T Rec. H.266 (VVC) and the like are used to produce compliant bitstreams tailored toward the consumption, after decoding by a compliant decoder, not by a human viewer but by a machine. According to an aspect of the disclosure, such a machine may care more about certain aspects of the content than a human viewer would. For example, a machine analyzing a traffic situation (such as in autonomous driving scenarios) cares for distance, speed, and acceleration of a convertible car that's being captured, but would not care about the clothing the driver of the convertible car wears, or the color of the convertible car, or whether it's dirty or clean.

In some examples, in order to guide decoders and receiving systems in what the encoder deems relevant and what is not for a specific video coding for machine scenario, it can be helpful to express in a bitstream which forms of optimization an encoder has applied. In some related examples, an encoder uses SEI message to indicate what optimization is applied at the encoder side to generate a bitstream. The information of the SEI message can be used at the decoder side to determine whether there is a mismatch of the optimization and intended use at the decoder side (or the receiving systems).

Some aspects of the disclosure provide signaling techniques of optimization that can address shortcomings and errors in the related examples, and can assist implementation of better video system, for example for machines. In some examples, the signaling of an optimization technique can be applied in a video codec bitstream to indicate at least three use states, such as a used state, a no-use state, and an unknown (use/no-use) state of one or more optimizations employed by an encoder. In some examples, the information of the used, no-use or unknown of the one or more optimizations can be conveyed persistence, for example in a single picture, in multiple pictures, or in a coded video sequence. In some examples, a syntax element, such as a syntax element in supplementary enhancement information (SEI) message, and the like is structured for the signaling of optimization techniques.

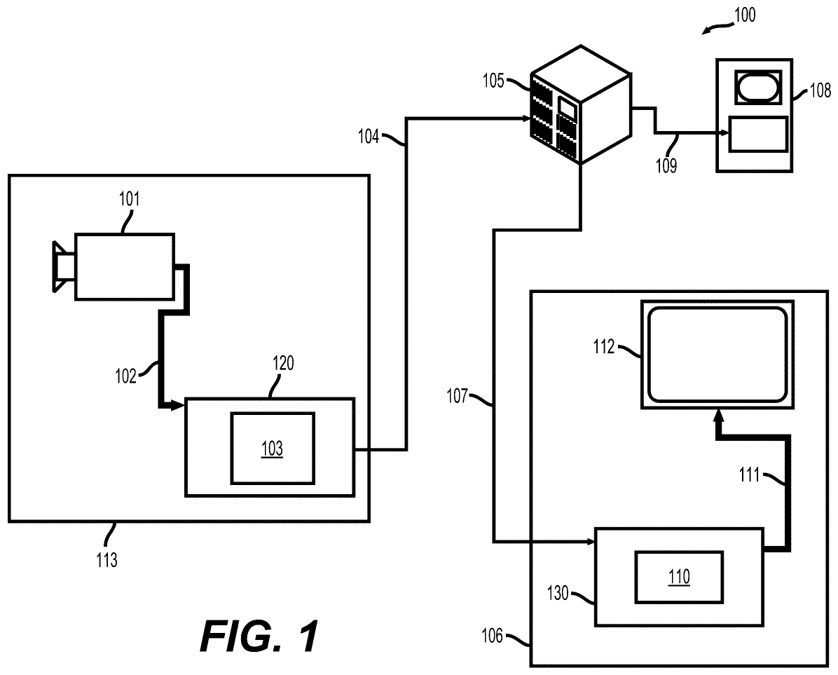

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

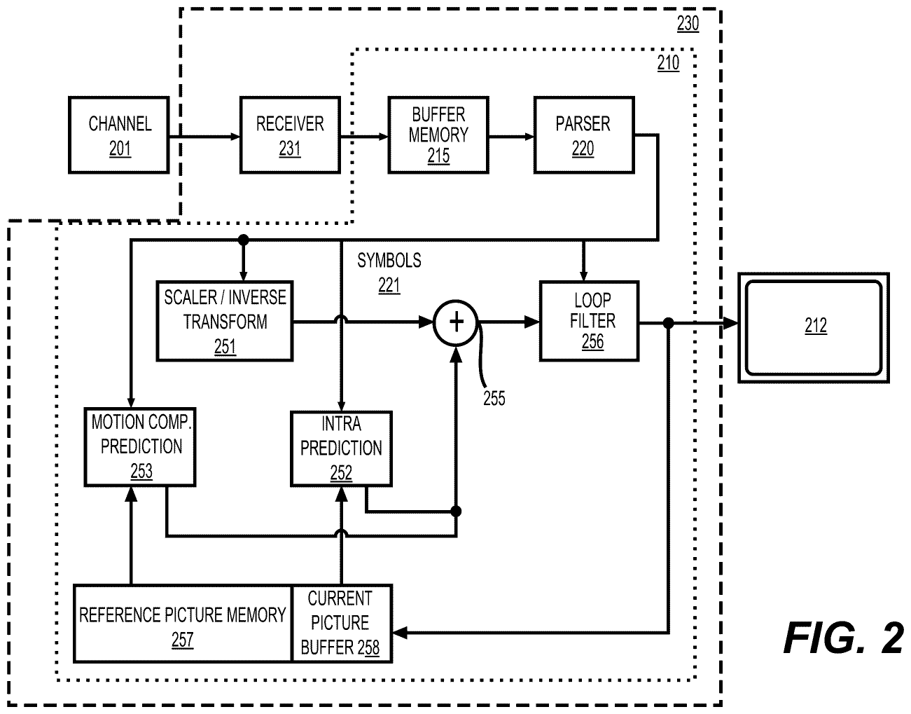

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) can receive one or more coded video sequences, included in a bitstream for example, to be decoded by the video decoder (210). In an embodiment, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

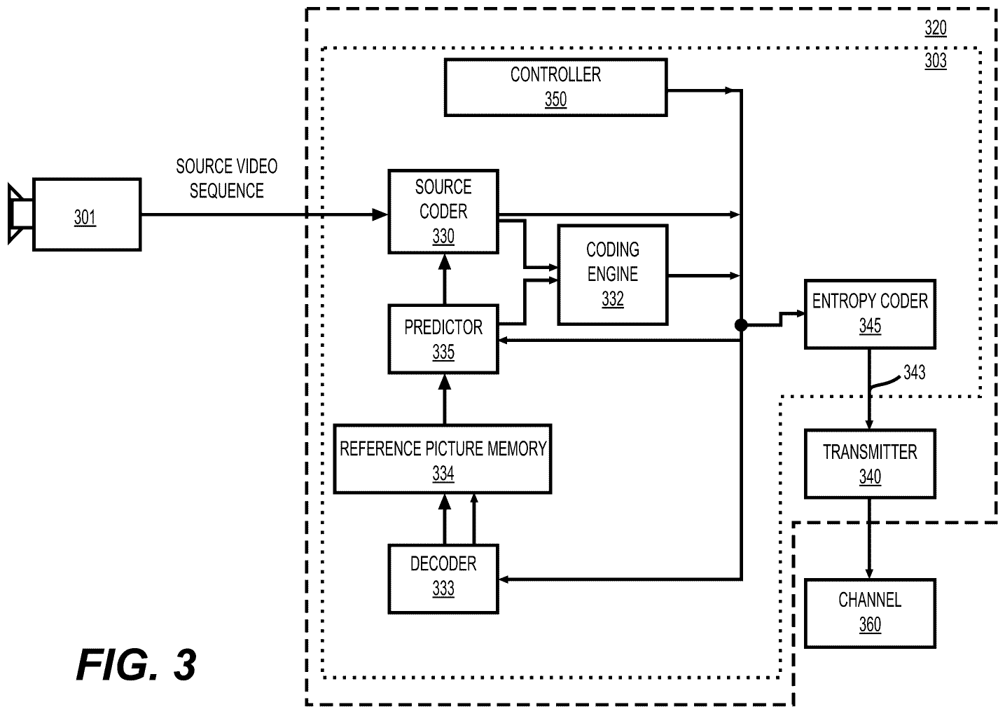

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an embodiment, the video encoder (303) may code and compress the pictures of the source video sequence into a coded video sequence (343) in real time or under any other time constraints as required. Enforcing appropriate coding speed is one function of a controller (350). In some embodiments, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some embodiments, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an embodiment, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an embodiment, the video encoders (103) and (303) and the video decoders (110) and (210) can be implemented using one or more integrated circuits. In another embodiment, the video encoders (103) and (303), and the video decoders (110) and (210) can be implemented using one or more processors that execute software instructions.

According to some aspects of the disclosure, a video coding can be used in machine scenarios.

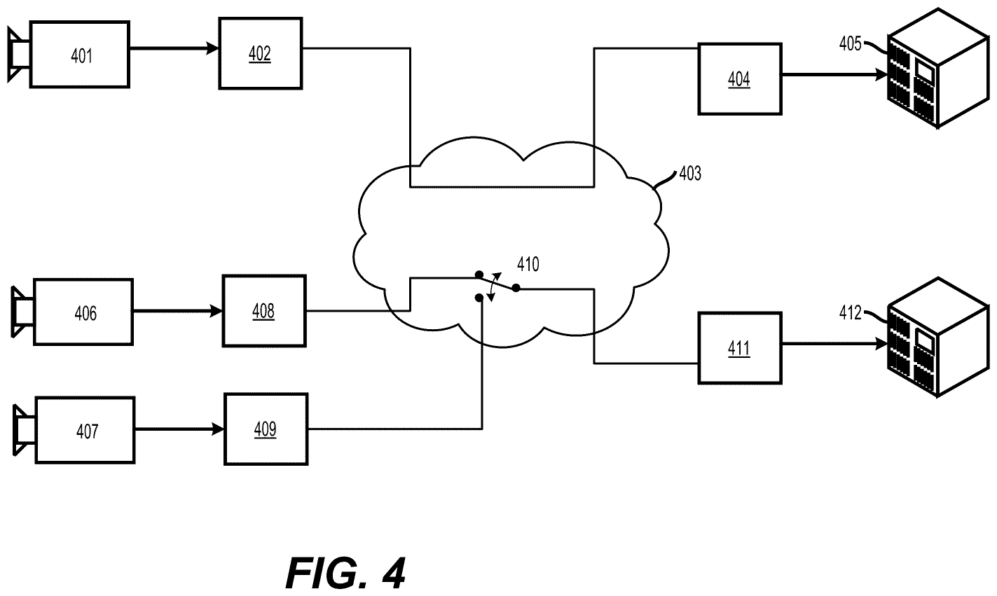

FIG. 4 shows a block diagram of a video processing system (400) in a machine scenario in some examples. In the FIG. 4 example, the video processing system (400) includes a plurality of video sources for machine consumption. For example, the video processing system (400) includes a camera (401) coupled to an encoder (402), a camera (406) coupled with an encoder (408), and a camera (407) coupled with an encoder (409).

In some examples, an encoder can be optimized for machine consumption. For example, the encoder (402) is optimized for encoding bitstreams for machine consumption. For example, the encoder (402) is coupled, via a network (403), to a decoder (404), and the decoder (404) is coupled to a machine (405) that consumes the decoded video (e.g., perform further analysis, detection, and the like on the video). Thus, an encoded bitstream can be provided from the encoder (402) to the decoder (404) via the network (403), and the encoded bitstream can be decoded by the decoder (404), and the decoded video data can be further processed by the machine (405).

It is noted that, in some examples, a machine may need to process videos from different video sources. In the FIG. 4 example, the video processing system (400) includes a machine (412) coupled with a decoder (411) to process videos from difference video sources via a switch (410) in the network (403). By controlling the switch (410), the machine (412) coupled with the decoder (411) can process encoded bitstream from the encoder (408) or can process encoded bitstream from the encoder (409). In some examples, a machine and a decoder coupled with the machine can be referred to as a receiving system. For example, the machine (412) and the decoder (411) form a receiving system.

According to an aspect of the disclosure, it can be advantageous for a receiving system to know what optimization techniques an encoder has employed while encoding a certain amount of video. It is noted that various optimization techniques can be applied at the encoder side, such as a region-of-interest (ROI) pre-processing (technique), a foreground pre-processing (technique), a background pre-processing (technique), a temporal sub-sampling (technique), a spatial sub-sampling (technique), a quantization parameter adaption for ROI (technique), a quantization step changes for temporal layers (technique), and the like.

According to an aspect of the disclosure, background and foreground are two components that contribute significantly to the overall impact of an image. Generally, the background refers to the area or space behind the main subject or elements in an image. For example, the background serves as the foundation and plays a role in setting the stage and creating context for the main subject or elements. Generally, the foreground refers to the area or space that appears in the immediate front of the main subject or elements. For example, the foreground acts as a frame and provides a context for the main subject, enabling the main subject to stand out and grab the viewer's attention.

In some examples, foreground and/or background segmentation can be performed, and suitable foreground pre-processing techniques and/or background pre-processing techniques can be applied to appropriate segments. In an example, a foreground segmentation algorithm (e.g., one of foreground pre-processing techniques) that segments moving objects from a relative static background can be performed to extract the foreground segments of moving objects, and other suitable foreground pre-processing techniques can be applied to the foreground segments. In another example, a background subtraction algorithm (e.g., one of background pre-processing techniques) that is based on training data can be performed on moving camera video for background and foreground segmentation, and further foreground pre-processing techniques can be applied to the foreground segments, and background pre-pre-processing techniques can be applied to the background segments.

In some examples, background pre-processing techniques can be applied to change visual properties, such as color, texture, pattern, depth, perspective, and the like of background elements.

In some examples, foreground pre-processing techniques can be applied for emphasizing. For example, the foreground pre-processing techniques can adjust various visual properties, such as focus, depth of field, angles, perspectives and the like of foreground elements.

The present disclosure uses some background pre-processing techniques and foreground pre-processing techniques as examples to illustrate methods for signaling optimization techniques, the methods for signaling optimization techniques can be applied to any suitable foreground pre-processing techniques and background pre-processing techniques. In some examples, the optimization techniques can also be signaled. A related example combines signaling for the foreground and background pre-processing techniques as a single optimization technique. According to the related example, a single syntax indicates both the foreground and the background pre-processing techniques are applied or none of the foreground and the background pre-processing techniques are applied. According to some aspects of the present disclosure, the optimization technique of foreground processing and the optimization technique of background processing are signaled individually in some examples. The individually signaling of the foreground pre-processing and the background pre-processing can provide detailed information of the application of the optimization techniques and can allow more optimization features. In an example, the foreground pre-processing can be applied without applying the background pre-processing. In another example, the background pre-processing can be applied without applying the foreground pre-processing. The individually signaling can be applied to other suitable optimization techniques. In some examples, a decoder can receive a coded video bitstream including coded information of one or more pictures. The decoder can determine a first signaled value of a first syntax element and a second signaled value of a second syntax element from the coded video bitstream, the first signaled value and the second signaled value are signaled individually, the first syntax element is associated with a first use state of a foreground pre-processing technique by an encoder that encodes the one or more pictures into the coded video bitstream, the second syntax element is associated with a second use state of a background pre-processing technique by the encoder. The decoder and/or a machine can process the coded information of the one or more pictures according to the first signaled value of the first syntax element and the second signaled value of the second syntax element.

According to some aspects of the disclosure, for an optimization technique, it can be advantageous to signal in a bitstream one of at least three use states for the optimization techniques. The three use states of the optimization technique can be referred to as a used state, a no-use state and an unknown state. For example, a bitstream can include one of the three use states, and a decoder can decode the signaled use state in the bitstream, and then operate accordingly. For example, a decoder can determine a signaled value of a syntax element from the coded video bitstream, the syntax element is associated with a use state of an optimization technique for encoding the one or more pictures into the coded video bitstream by an encoder, the syntax element is structured to have at least three possible values corresponding to three use states of the optimization technique, a first value of the syntax element indicates an unknown state of the optimization technique for encoding the one or more pictures, a second value of the syntax element indicates a used state of the optimization technique for encoding the one or more pictures, and a third value of the syntax element indicates a no-use state of the optimization technique for encoding the one or more pictures.

In some examples, a first state (also referred to as used state) of an optimization technique can indicate that the optimization technique has been used at the encoder side. In an example, upon reception and decoding of such information by a receiving system, a decoder of the receiving system can rely on the knowledge that the optimization technique has been used, and adequately react to it.

In the FIG. 4 example, based on a signaling of the first state, the decoder (404) has established knowledge that quantization parameters have been adapted based on region of interest by the encoder (402), the decoder (404) can use the established knowledge as a heuristic to direct priority of image analysis tools running in the machine (405) towards that region of interest. For example, in a video coding for machines system in a traffic supervision scenario, the encoder (402) codes identified license plates as regions of interest (ROI) and codes the ROI with particularly fine quantization so to preserve detail. At the receiving system, the decoder (404) can use the information of the ROI to direct an optical character recognition (OCR) module in the machine (405) to reconstructed picture areas that were coded with particularly fine quantization. Thus, the machine (405) can recognize characters of the license plates.

In some examples, a second state (also referred to as no-use state) can indicate that the optimization technique has not been used at the encoder side. In an example, based on a signaling of the second state, the decoder (404) can determine not to rely on knowledge that the optimization technique has been used. According to an aspect of the disclosure, it can be disadvantageous of the decoder (404) to draw special attention of license plate OCR readers in the machine (405) to areas of the picture that have been coded with a fine QP, because such fine QP is not an indication of an identified region of interest. Thus, with the signaling of the second state, such disadvantageous of the decoder (404) can be avoided.

In some examples, a third state (also referred to as unknown state) can indicate that the used or no-use states of the optimization technique is not known. In some examples, optimization techniques are conveyed in a bitstream by optional syntax mechanisms, such as using SEI messages, the third state can be a default in a decoder of a receiving system until more definite information according to the first state or a second state is received. According to an aspect of the disclosure, specifically signaling the unknown state can be beneficial, for example, in the machine scenario. For example, the camera (406) and the encoder (408) coupled with the camera (406) are in a legacy traffic camera system, and the camera (407) and the encoder (409) coupled with the camera (407) are in a modern traffic camera system. In an example, the legacy traffic camera system does not support optimization technique signaling, and the modern traffic camera system supports optimization technique signaling. The switch (410) is a video switch in the compressed domain and can be controlled to switch between the legacy traffic camera system and the modern traffic camera system. In an example, when the switch (410) switches from the modern traffic camera system to the legacy traffic camera system, the established knowledge at the decoder (411) can be the state that is left behind by the modern traffic camera system. The legacy traffic camera system does not support the optimization technique signaling, the bitstream generated by the legacy traffic camera system does not include the inserted information about optimization techniques. In some examples, the switch (410) can be configured to insert something in the bitstream. For example, since the switch (410) is a compressed domain device and has no knowledge, nor a way to derive such knowledge, of which optimization techniques the legacy traffic camera system has used, the switch (410) can insert information that indicates the optimization techniques are unknown, such as the unknown state. It is noted that, in an example, inserting other information, such as optimization techniques not being used, can be misleading to the receiving system. The switch (410) can be any suitable device that has the ability to insert suitable information into the bitstream. The switch (410) can be network switch, server and can be a device with processing circuitry and software is running on the processing circuitry.

In some embodiments, the at least three states described above can be included in a bitstream with a per optimization technique scenario. For example, in a traffic camera scenario, a plurality of traffic camera systems can be used, such as a legacy traffic camera system, a first generation traffic camera system, and a second generation traffic camera system. The second generation traffic camera system can offer information about more optimization techniques than the first generation traffic camera system, whereas the legacy traffic camera system provides no such information.

According to an aspect of the disclosure, when a video bitstream syntax only includes two states (e.g., the used state and no-use state) to indicate optimization on or optimization off, the receiving system can receive misleading information and perform in a significant disadvantage manner as described above. In some examples, the switch (410) is a video switch and can insert a syntax of unknown state for the optimization technique when the switch (410) switches between video sources. Thus, at the receiving system side, the receiving system can look for other information to make right decision about the optimization technique. In some examples, for compression or other reasons, the three state model is not acceptable, a partial solution can be used. In the partial solution, a single bit with two values is used, one of the two values, for example 1, indicates that an optimization technique has been used, whereas the other value, for example 0, indicates that the use of an optimization technique is unknown. It is noted that “unknown” is semantically different from “off”.

According to some video coding standards, such as VVC, on/off information can be coded by a single flag occupying one bit in a bitstream, commonly represented as u(1). Information that has three values (0 . . . 2) (e.g., three states) can be coded, for example, as a two bit fixed length codeword (u(2)), or with a variable length codeword with, for example ext-golomb codes, that can be represented as ue(v).

In some examples, the used, no-use and unknown states of optimization techniques can be described per optimization technique. For example, for each optimization technique, value “0” indicates the unknown state, value “1” indicates the used state, and value “2” indicates the no-use state. In an example, the values can be represented in a ue(v) coded codeword. In another example, the values can be represented in a u(2) coded codeword.

According to an aspect of the disclosure, syntax for a supplementary enhancement information (SEI) message can be used for signaling optimization techniques. In an example, a syntax uses the ue(v) coded codeword for the three-state optimization technique signaling. In another example, a syntax uses u(1) single bit signaling to distinguish between “on” and “unknown”. It is noted that SEI message is described as an example to include the information of optimization techniques, the information of optimization techniques can be included at other locations in the bitstream. In an example, optimization technique information is a part of the visual usability information syntax (part of the sequence parameter set), located in any of slice header, picture header, GOB header, GOP header, or any parameter set including picture, adaptation, sequence, video parameter set.

In some embodiments, in order to save bits in the syntax, signaling for semantically similar optimization techniques can be grouped into a group, with each group gated by a presence flag. In an example, a single group is used for grouping of region-of-interest related optimization techniques. It is noted that other suitable groupings can be derived.

In some embodiments, the presence or absence of optimization technique signaling is indicated through a flag.

In some embodiments, an initial state at a decoder with respect to optimization information before receiving a first SEI message (such as: at the start of a coded video sequence) can be set to an unknown state for each of optimization techniques. Such a mechanism can have the highest chance for cross vendor interoperability.

In some embodiments, the initial state at a decoder with respect to optimization information before receiving the first SEI message can be “on” or “off”, for all or a subset of the optimization techniques. In some examples, pre-defining such information can save bitrate, since the SEI message is not necessarily be sent. However, doing so requires pre-established knowledge between encoder and decoder on what optimization techniques an encoder is to use. The pre-established knowledge can be established through signaling outside of the video bitstream (for example during capability exchange), by cross-vendor agreements, and the like.

In some embodiments, the SEI message includes persistence information that indicates the information included in the SEI message persists over a number of pictures, access units, time, blocks/CTUs, coded video sequences (CVSs) or other specified units of the bitstream. In some examples, a single bit is used to be indicative of the SEI message pertaining to the picture (for single-layer bitstreams)/access unit (for multilayer bitstreams), as the case may be, or to the remainder of the coded video sequence.

In some examples, when a persistence is signaled that is less than a coded video sequence, upon the end of the persistence interval, the state of the optimization techniques at the decoder is specified as being the unknown state.

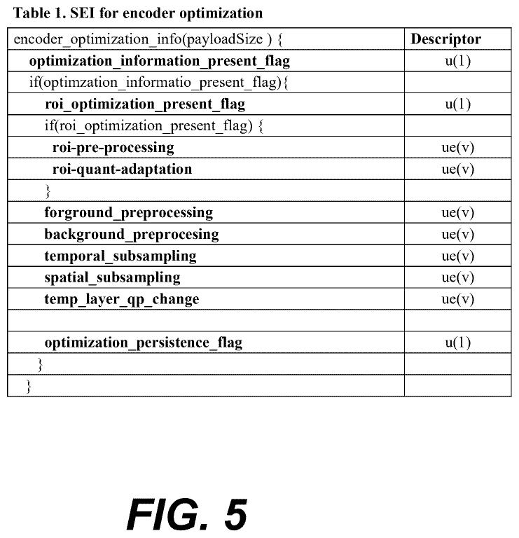

FIG. 5 shows a table of syntaxes and semantics that can be a part of an SEI message in some examples.

In the FIG. 5 example, a flag optimization_information_present_flag equal to 1 specifies that optimization information is present and is to be applied as indicated by the persistence information. The flag optimization_information_present_flag euqal to 0 specifies that optimization information is not present and the decoder/receiver needs to assume to be the unknown state.

In the FIG. 5 example, a flag roi_optimization_present_flag equal to 1 specifies that roi_pre_processing and roi_quanty_adaptaion are present. The flag roi_optimization_present_flag equal to 0 specifies that roi_pre_processing and roi_quanty_adaptaion are not present.

In the FIG. 5 example, syntaxes roi_pre_processing, roi-quant_adapation, foreground_preprocessing, background_preprocessing, temporal_subsampling, spatial_subsampling, temp_layer_qp_change are used to respectively indidate states of optimization techniques. The syntax roi_pre_processing is used to indicae the state of ROI pre-prosessing, the syntax roi-quant_adapation is used to indicate the state of ROI based quantization adaption, the syntax foreground_preprocessing is used to indicate the state of foreground pre-processing, the syntax background_preprocessing is used to indicate the state of background preprocessing, the syntax temporal_subsampling is used to indicate the state of temporal subsampling, the syntax spatial_subsampling is used to indicate the state of spatial subsampling, the syntax temp_layer_qp_change is used to indicate temp layer quantization paramter change. In an example, the value 0 of a syntax for an optimization technique specifies that the use of the optimization technique is unknown; the value 1 of a syntax for an optimziation technique specifies that the optimization technique is in use; the value 2 of a syntax for an optimization technqiue specifies that the optimization technqiue is not in use. It is noted that other values of the syntaxes can be reserved.

In the FIG. 5 example, a persistence flag optimization_persistence_flag specifies the persistence of the optimization information that is indicated by the syntax elements gated by a present flag optimization_information_present_flag. The persistence flag optimization_persistence_flag equal to 0 specifies that the optimization information applies for the current picture only. The optimization information can be reset to the unknown state until an SEI message of optimization (e.g., an encoder_optimization_info SEI message) is received with optimization_informagtion_present_flag equal to 1. The persistence flag optimization_persistence_flag equal to 1 specifies that the optimization method identified by the optimization_method applies for the current picture and all subsequent pictures.

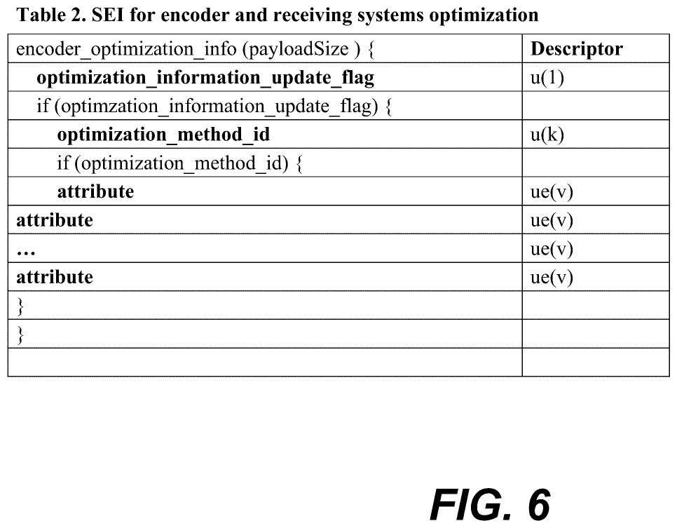

FIG. 6 shows another table of syntaxes and semantics that can be a part of an SEI message in some examples. In the FIG. 6 example, a flag optimization_information_present_flag equal to 1 specifies that optimization information is updated for the current picture. The flag optimization_information_present_flag euqal to 0 specifies that optimization information is not updated and the optimization method and the attributes associated with the optimization method applied to previously coded picture are used for the current picture. When the flag is used for the first time, the value can be set to 1.

In the FIG. 6 example, the syntax “optimization_method_id” speicifies the index of the optimization method applied to the current picture. When the value of the syntax is equal to 0, no optimization is applied. The syntax attribute can be used to specify the value of an attribute for a certain optimization method, such as resampling rate, bounding box and ROI coordinates, and the like.

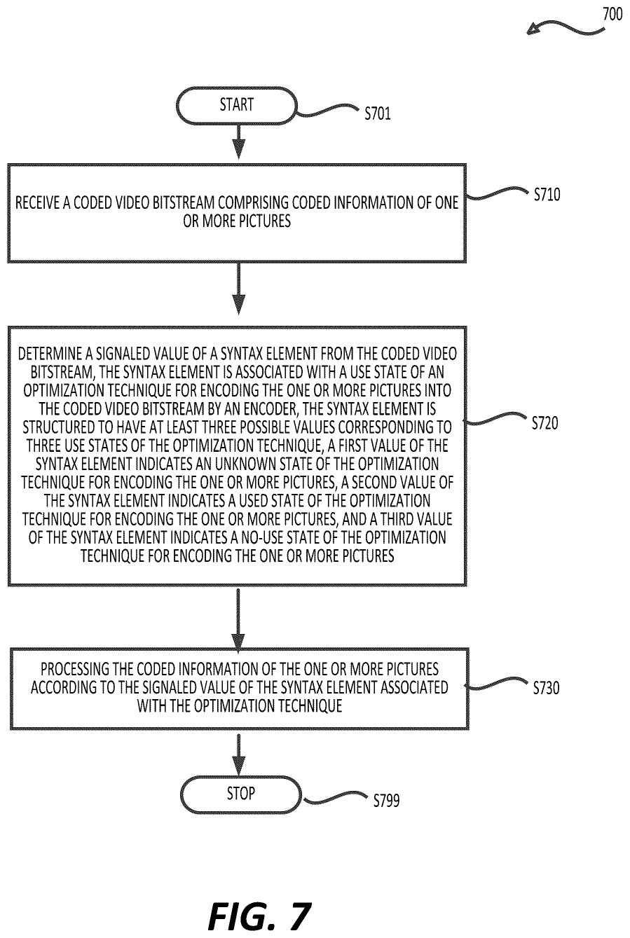

FIG. 7 shows a flow chart outlining a process (700) according to an embodiment of the disclosure. The process (700) can be used in a video decoder. In various embodiments, the process (700) is executed by processing circuitry, such as the processing circuitry that performs functions of the video decoder (110), the processing circuitry that performs functions of the video decoder (210), the processing circuitry that performs functions of the video decoder (404), the processing circuitry that performs functions of the video decoder (411) and the like. In some embodiments, the process (700) is implemented in software instructions, thus when the processing circuitry executes the software instructions, the processing circuitry performs the process (700). The process starts at (S701) and proceeds to (S710).

At (S710), a coded video bitstream including coded information of one or more pictures is received.

At (S720), a signaled value of a syntax element is determined from the coded video bitstream. The syntax element is associated with a use state of an optimization technique for encoding the one or more pictures into the coded video bitstream by an encoder. The syntax element is structured to have at least three possible values corresponding to three use states of the optimization technique, a first value of the syntax element indicates an unknown state of the optimization technique for encoding the one or more pictures, a second value of the syntax element indicates a used state of the optimization technique for encoding the one or more pictures, and a third value of the syntax element indicates a no-use state of the optimization technique for encoding the one or more pictures.

At (S730), the coded information of the one or more pictures is processed according to the signaled value of the syntax element associated with the optimization technique. In an example, the use state of the optimization technique is provided to a machine for further video processing accordingly.

In some examples, the optimization technique includes at least one of: a region-of-interest (ROI) pre-processing technique, a foreground pre-processing technique, a background pre-processing technique, a temporal sub-sampling technique, a spatial sub-sampling technique, a quantization parameter adaption for ROI technique and a quantization step changes for temporal layers technique.

In some examples, the syntax element is parsed from a supplementary enhancement information (SEI) message.

In some examples, the syntax element is parsed from at least one of a sequence parameter set, a video parameter set, a picture parameter set, an adaptation parameter set, a picture header, a slice header, a group of block (GOB) header, and a group of picture (GOP) header.

In some examples, to determine the signaled value of the syntax element, the coded information is parsed to obtain a presence flag that indicates whether a group of syntax elements for a group of optimization techniques is present in the coded information. When the presence flag indicates an existence of the group of syntax elements, the coded information is parsed to obtain values of the group of syntax elements.

In some examples, an initial state of the optimization technique is set to be the unknown state.

In some examples, a persistence interval for the optimization technique is determined based on a persistence that is signaled in the coded information. Then, the use state of the optimization technique is set to be the unknown state upon an end of the persistence interval.

In some examples, a first signaled value of a first syntax element and a second signaled value of a second syntax element are determined from the coded information of the one or more pictures, the first syntax element is associated with a first use state of a foreground pre-processing technique on the one or more pictures, the second syntax element is associated with a second use state of a background pre-processing technique on the one or more pictures.

In some examples, the signaled value of the syntax element indicates the unknown state, the signaled value of the syntax element is inserted by a device that is configured to switch from a first source to a second source for providing the coded video bitstream.

In some examples, an update flag is parsed from the coded video bitstream, the update flag indicates whether an update to one or more optimization techniques is coded into the coded information. When the update flag indicates that the update is coded into the coded information, a specific optimization technique is determined based on an identification of the specific optimization technique in the coded video bitstream, and one or more attributes of the specific optimization technique are determined from the coded video bitstream.

Then, the process proceeds to (S799) and terminates.

The process (700) can be suitably adapted. Step(s) in the process (700) can be modified and/or omitted. Additional step(s) can be added. Any suitable order of implementation can be used.

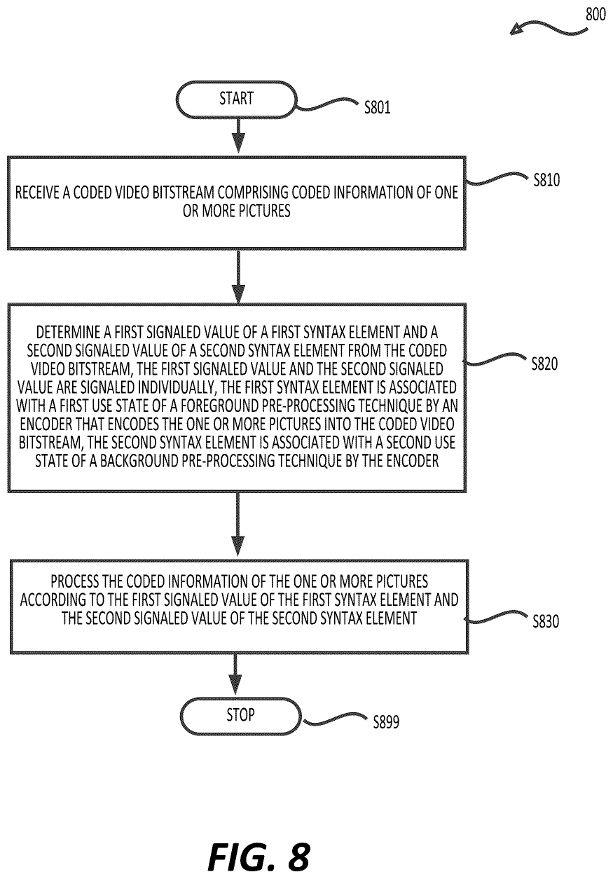

FIG. 8 shows a flow chart outlining a process (800) according to an embodiment of the disclosure. The process (800) can be used in a video decoder. In various embodiments, the process (800) is executed by processing circuitry, such as the processing circuitry that performs functions of the video decoder (110), the processing circuitry that performs functions of the video decoder (210), and the like. In some embodiments, the process (800) is implemented in software instructions, thus when the processing circuitry executes the software instructions, the processing circuitry performs the process (800). The process starts at (S801) and proceeds to (S810).

At (S810), a coded video bitstream including coded information of one or more pictures is received.

At (S820), a first signaled value of a first syntax element and a second signaled value of a second syntax element are determined from the coded video bitstream, the first signaled value and the second signaled value are signaled individually, the first syntax element is associated with a first use state of a foreground pre-processing technique by an encoder that encodes the one or more pictures into the coded video bitstream, the second syntax element is associated with a second use state of a background pre-processing technique by the encoder.

At (S830), the coded information of the one or more pictures is processed according to the first signaled value of the first syntax element and the second signaled value of the second syntax element. In some examples of machine scenario, the first use state of the foreground processing and the second use state of the background pre-processing are provided to a machine for further video processing.

In some examples, the first syntax element is structured to have at least two possible values corresponding to two use states of the foreground pre-processing technique, a first value of the first syntax element indicates a used state of the foreground pre-processing technique for encoding the one or more pictures, and a second value of the first syntax element indicating a no-use state of the foreground pre-processing technique for encoding the one or more pictures.

In some examples, the second syntax element is structured to have at least two possible values corresponding to two use states of the background pre-processing technique, a first value of the second syntax element indicates a used state of the background pre-processing technique for encoding the one or more pictures, and a second value of the second syntax element indicating a no-use state of the background pre-processing technique for encoding the one or more pictures.

In some examples, the first syntax element is structured to have at least three possible values corresponding to three use states of the foreground pre-processing technique, a first value of the first syntax element indicates an unknown state of the foreground pre-processing technique for encoding the one or more pictures, a second value of the first syntax element indicates a used state of the foreground pre-processing technique for encoding the one or more pictures, and a third value of the first syntax element indicates a no-use state of the foreground pre-processing technique for encoding the one or more pictures.

In some examples, the second syntax element is structured to have at least three possible values corresponding to three use states of the background pre-processing technique, a first value of the second syntax element indicates an unknown state of the background pre-processing technique for encoding the one or more pictures, a second value of the second syntax element indicates a used state of the background pre-processing technique for encoding the one or more pictures, and a third value of the second syntax element indicates a no-use state of the background pre-processing technique for encoding the one or more pictures.

In some examples, the first syntax element and the second syntax element are parsed from a supplementary enhancement information (SEI) message.

In some examples, the first syntax element and the second syntax element are parsed from at least one of a sequence parameter set, a video parameter set, a picture parameter set, an adaptation parameter set, a picture header, a slice header, a group of block (GOB) header, and a group of picture (GOP) header.

In some examples, the coded information is parsed to obtain a presence flag that indicates whether a group of at least the first syntax element and the second syntax element is present in the coded information. When the presence flag indicates an existence of the group of at least the first syntax element and the second syntax element, the coded information is parsed to obtain the first signaled value of the first syntax element and the second signaled value of the second syntax element.

Then, the process proceeds to (S899) and terminates.

The process (800) can be suitably adapted. Step(s) in the process (800) can be modified and/or omitted. Additional step(s) can be added. Any suitable order of implementation can be used.

It is noted that the above techniques can be used to perform a conversion between a visual media file and a bitstream of visual media data according to a format rule. For example, the bitstream includes a first signaled value of a first syntax element and a second signaled value of a second syntax element, the first signaled value and the second signaled value are signaled individually, the first syntax element is associated with a first use state of a foreground pre-processing technique, the second syntax element is associated with a second use state of a background pre-processing technique. The format rule specifies that the first syntax element is structured to have at least three possible values corresponding to three use states of the foreground pre-processing technique, a first value of the first syntax element indicates an unknown state of the foreground pre-processing technique, a second value of the first syntax element indicating a used state of the foreground pre-processing technique, and a third value of the first syntax element indicating a no-use state of the foreground pre-processing technique. Further, the format rule specifies that the second syntax element is structured to have at least three possible values corresponding to three use states of the background pre-processing technique, a first value of the second syntax element indicates an unknown state of the background pre-processing technique, a second value of the second syntax element indicating a used state of the background pre-processing technique, and a third value of the second syntax element indicating a no-use state of the background pre-processing technique.

In an example, the format rule specifies that the first syntax element and the second syntax element are reset to the unknown state upon an end of a persistence interval.

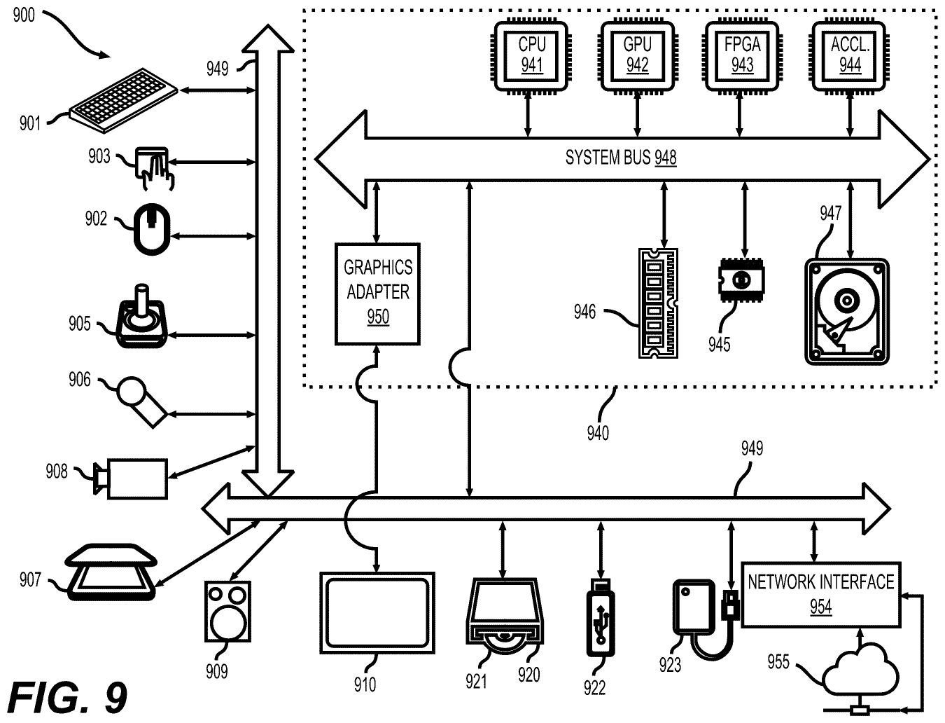

The techniques described above, can be implemented as computer software using computer-readable instructions and physically stored in one or more computer-readable media. For example, FIG. 9 shows a computer system (900) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 9 for computer system (900) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (900).

Computer system (900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (901), mouse (902), trackpad (903), touch screen (910), data-glove (not shown), joystick (905), microphone (906), scanner (907), camera (908).

Computer system (900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (910), data-glove (not shown), or joystick (905), but there can also be tactile feedback devices that do not serve as input devices), audio output devices (such as: speakers (909), headphones (not depicted)), visual output devices (such as screens (910) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (900) can also include human accessible storage devices and their associated media such as optical media including CD/DVD ROM/RW (920) with CD/DVD or the like media (921), thumb-drive (922), removable hard drive or solid state drive (923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (900) can also include an interface (954) to one or more communication networks (955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (949) (such as, for example USB ports of the computer system (900)); others are commonly integrated into the core of the computer system (900) by attachment to a system bus as described below (for example Ethernet interface into a PC computer system or cellular network interface into a smartphone computer system). Using any of these networks, computer system (900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (940) of the computer system (900).

The core (940) can include one or more Central Processing Units (CPU) (941), Graphics Processing Units (GPU) (942), specialized programmable processing units in the form of Field Programmable Gate Areas (FPGA) (943), hardware accelerators for certain tasks (944), graphics adapters (950), and so forth. These devices, along with Read-only memory (ROM) (945), Random-access memory (946), internal mass storage such as internal non-user accessible hard drives, SSDs, and the like (947), may be connected through a system bus (948). In some computer systems, the system bus (948) can be accessible in the form of one or more physical plugs to enable extensions by additional CPUs, GPU, and the like. The peripheral devices can be attached either directly to the core's system bus (948), or through a peripheral bus (949). In an example, the screen (910) can be connected to the graphics adapter (950). Architectures for a peripheral bus include PCI, USB, and the like.

CPUs (941), GPUs (942), FPGAs (943), and accelerators (944) can execute certain instructions that, in combination, can make up the aforementioned computer code. That computer code can be stored in ROM (945) or RAM (946). Transitional data can also be stored in RAM (946), whereas permanent data can be stored for example, in the internal mass storage (947). Fast storage and retrieve to any of the memory devices can be enabled through the use of cache memory, that can be closely associated with one or more CPU (941), GPU (942), mass storage (947), ROM (945), RAM (946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (900), and specifically the core (940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (940) that are of non-transitory nature, such as core-internal mass storage (947) or ROM (945). The software implementing various embodiments of the present disclosure can be stored in such devices and executed by core (940). A computer-readable medium can include one or more memory devices or chips, according to particular needs. The software can cause the core (940) and specifically the processors therein (including CPU, GPU, FPGA, and the like) to execute particular processes or particular parts of particular processes described herein, including defining data structures stored in RAM (946) and modifying such data structures according to the processes defined by the software. In addition or as an alternative, the computer system can provide functionality as a result of logic hardwired or otherwise embodied in a circuit (for example: accelerator (944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A non-transitory computer-readable storage medium storing instructions which when executed by a processor cause the processor to perform an encoding method, the encoding method comprising:
encoding one or more pictures into coded information of the one or more pictures in a video media bitstream, the coded information including a signaled value of a syntax element, the syntax element being associated with a use state of an optimization technique for the encoding, the syntax element being structured to have at least three possible values corresponding to three use states of the optimization technique, a first value of the syntax element indicating an unknown state of the optimization technique for the encoding the one or more pictures, a second value of the syntax element indicating a used state of the optimization technique for the encoding the one or more pictures, and a third value of the syntax element indicating a no-use state of the optimization technique for the encoding the one or more pictures; and
transmitting the video media bitstream.

2. The non-transitory computer-readable storage medium of claim 1, wherein the optimization technique includes at least one of:
a region-of-interest (ROI) pre-processing technique;
a foreground pre-processing technique;
a background pre-processing technique;
a temporal sub-sampling technique;
a spatial sub-sampling technique;
a quantization parameter adaption for ROI technique; and
a quantization step changes for temporal layers technique.

3. The non-transitory computer-readable storage medium of claim 1, wherein the syntax element is included in at least one of a supplementary enhancement information (SEI) message, a sequence parameter set, a video parameter set, a picture parameter set, an adaptation parameter set, a picture header, a slice header, a group of block (GOB) header, and a group of picture (GOP) header.

4. A method of video decoding, comprising:
receiving a coded video bitstream comprising coded information of one or more pictures;
determining a signaled value of a syntax element from the coded video bitstream, the syntax element being associated with a use state of an optimization technique for encoding the one or more pictures into the coded video bitstream by an encoder, the syntax element being structured to have at least three possible values corresponding to three use states of the optimization technique, a first value of the syntax element indicating an unknown state of the optimization technique for encoding the one or more pictures, a second value of the syntax element indicating a used state of the optimization technique for encoding the one or more pictures, and a third value of the syntax element indicating a no-use state of the optimization technique for encoding the one or more pictures; and
processing the coded information of the one or more pictures according to the signaled value of the syntax element associated with the optimization technique.

5. The method of claim 4, wherein the optimization technique includes at least one of:
a region-of-interest (ROI) pre-processing technique;
a foreground pre-processing technique;
a background pre-processing technique;
a temporal sub-sampling technique;
a spatial sub-sampling technique;
a quantization parameter adaption for ROI technique; and
a quantization step changes for temporal layers technique.

6. The method of claim 4, wherein the syntax element is parsed from a supplementary enhancement information (SEI) message.

7. The method of claim 4, wherein the syntax element is parsed from at least one of a sequence parameter set, a video parameter set, a picture parameter set, an adaptation parameter set, a picture header, a slice header, a group of block (GOB) header, and a group of picture (GOP) header.

8. The method of claim 4, wherein the determining the signaled value of the syntax element further comprises:
parsing the coded information to obtain a presence flag that indicates whether a group of syntax elements for a group of optimization techniques is present in the coded information; and
when the presence flag indicates an existence of the group of syntax elements, parsing the coded information to obtain values of the group of syntax elements.

9. The method of claim 4, further comprising:
setting an initial state of the optimization technique to be the unknown state.

10. The method of claim 4, further comprising:
determining a persistence interval for the optimization technique based on a persistence that is signaled in the coded information; and
setting the use state of the optimization technique to be the unknown state upon an end of the persistence interval.

11. The method of claim 4, further comprising:
determining a first signaled value of a first syntax element and a second signaled value of a second syntax element from the coded information of the one or more pictures, the first syntax element being associated with a first use state of a foreground pre-processing technique on the one or more pictures, the second syntax element being associated with a second use state of a background pre-processing technique on the one or more pictures.

12. The method of claim 4, wherein the signaled value of the syntax element indicates the unknown state, the signaled value of the syntax element is inserted by a device that is configured to switch from a first source to a second source for providing the coded video bitstream.

13. The method of claim 4, further comprising:
parsing an update flag from the coded video bitstream, the update flag indicating whether an update to one or more optimization techniques is coded into the coded information;
when the update flag indicates that the update is coded into the coded information, determining a specific optimization technique based on an identification of the specific optimization technique in the coded video bitstream; and
determining one or more attributes of the specific optimization technique from the coded video bitstream.

14. The method of claim 11, wherein the foreground pre-processing technique adjusts a visual property of a foreground element, and the background pre-processing technique adjusts a visual property of a background element.

15. The method of claim 4, wherein the unknown state of the optimization technique indicates that whether the optimization technique is used for encoding the one or more pictures is unknown, the used state of the optimization technique indicate that the optimization technique is used for encoding the one or more pictures, and the no-use state of the optimization technique indicates that the optimization technique is not used for encoding the one or more pictures.

16. An apparatus for video decoding, comprising processing circuitry configured to:
receive a coded video bitstream comprising coded information of one or more pictures;
determine a first signaled value of a first syntax element and a second signaled value of a second syntax element from the coded video bitstream, the first signaled value and the second signaled value being signaled individually, the first syntax element being associated with a first use state of a foreground pre-processing technique by an encoder that encodes the one or more pictures into the coded video bitstream, the second syntax element being associated with a second use state of a background pre-processing technique by the encoder; and
process the coded information of the one or more pictures according to the first signaled value of the first syntax element and the second signaled value of the second syntax element,
wherein the first syntax element is structured to have at least three possible values corresponding to three use states of the foreground pre-processing technique, a first value of the first syntax element indicates an unknown state of the foreground pre-processing technique for encoding the one or more pictures, a second value of the first syntax element indicates a used state of the foreground pre-processing technique for encoding the one or more pictures, and a third value of the first syntax element indicates a no-use state of the foreground pre-processing technique for encoding the one or more pictures.

17. The apparatus of claim 16, wherein the second syntax element is structured to have at least three possible values corresponding to three use states of the background pre-processing technique, a first value of the second syntax element indicates an unknown state of the background pre-processing technique for encoding the one or more pictures, a second value of the second syntax element indicates a used state of the background pre-processing technique for encoding the one or more pictures, and a third value of the second syntax element indicates a no-use state of the background pre-processing technique for encoding the one or more pictures.

18. The apparatus of claim 16, wherein the first syntax element and the second syntax element are parsed from a supplementary enhancement information (SEI) message.

19. The apparatus of claim 16, wherein the first syntax element and the second syntax element are parsed from at least one of a sequence parameter set, a video parameter set, a picture parameter set, an adaptation parameter set, a picture header, a slice header, a group of block (GOB) header, and a group of picture (GOP) header.

20. The apparatus of claim 16, wherein the processing circuitry is configured to:
parse the coded information to obtain a presence flag that indicates whether a group of at least the first syntax element and the second syntax element is present in the coded information; and
when the presence flag indicates an existence of the group of at least the first syntax element and the second syntax element, parse the coded information to obtain the first signaled value of the first syntax element and the second signaled value of the second syntax element.
